(19) United States
(12) Patent Application Publication
(10) Pub. No.: US 2015/0113468 A1
(43) Pub. Date: Apr. 23, 2015

(54) System and method of inputting time on an electronic device having a touch screen

(71) Applicant: Richard Lawrence Clark, Aptos, CA (US)

(72) Inventor: Richard Lawrence Clark, Aptos, CA (US)

(21) Appl. No.: 14/579,113

(22) Filed: Dec. 22, 2014

Related U.S. Application Data
(63) Continuation-in-part of application No. 14/033,518, filed on Sep. 23, 2013.
(60) Provisional application No. 61/704,669, filed on Sep. 24, 2012.

(51) Int. Cl. G06F 3/0488; G06F 3/0484; G06F 3/0482

(52) U.S. Cl. CPC G06F 3/04886; G06F 3/0482; G06F 3/04842
USPC 715/773

(57) ABSTRACT

A system and method of inputting time on an electronic device having a touch screen that displays a graphical hour keypad and detects user touch input to select an hour from the keypad, and displays, either simultaneously with the hour keypad, or following selection of an hour, a graphical minute keypad and detects user touch input to select a minute from the keypad. The selection could also be done in reverse order. The hour keypad can include one 24-key keypad or two 12-key sub-keypads and the minute keypad can include one 60-key keypad and/or one 12-key keypad. If the 60-key minute keypad is not used, the user can enter a minute that is not a multiple of five by using a standard 10-digit numeric keypad, incorporating movement events or pull events, or causing a sub-keypad to be displayed. A slide gesture can be employed to select both hour and minute.

### CROSS REFERENCE TO RELATED APPLICATIONS

This application is a continuation-in-part of U.S. patent application Ser. No. 14/033,518 filed on Sep. 23, 2013, which in turn claims the benefit of U.S. Prov. Pat. App. No. 61704669 filed on Sep. 24, 2012, the entireties of which are hereby incorporated by reference.

### BACKGROUND OF THE INVENTION

Field of the invention: This invention relates to the general field of time keeping, and more specifically toward a system and method of inputting time on an electronic device having a touch screen. A computer system displays a graphical hour keypad and detects user touch input to select an hour from the keypad, and displays a graphical minute keypad and detects user touch input to select a minute from the keypad. The keypads have 12, 24, or 60 keys, in the various configurations described herein. Additionally, for selecting a minute that is not a multiple of five, which is rarely needed for most day-to-day uses, a 12-key minute keypad may have a standard numeric 10-digit keypad as a co-keypad, or may have sub-keypads having various numbers of keys.

The use of non-standard numeric keypads, such as keypads that do not have just ten numeric keys labeled 0 to 9, can enable a user to enter a time in just a few user actions.

For decades, entering time on an electronic device has been a tedious task. One such method of entering time includes the “spin” button, primarily seen on alarm clocks.

A button is held down and the time cycles through an entire day. The button is released when the appropriate time has been reached. Usually, there is a back button that allows a user to reverse through time if the appropriate time was inadvertently passed. In general, the speed of the spin varies—slow at first, then fast after time progresses, such as a second or so. Some clocks allow fast spinning mode in both directions. An alternative method includes spinning the hours and minutes separately, through either separate buttons for each or using “up” and “down” buttons along with a button to select hours or minutes. In a 12-hour clock, there is also a selection for AM or PM.

Another previously disclosed method includes a standard numeric keypad, which is used on almost all microwave ovens. A user enters a cooking time by pressing keys 0 through 9. For setting the clock time, there may also be an AM/PM toggle.

When Apple Inc. introduced the iPhone®, they provided a time setter “widget” that was similar to the spinners discussed above, but instead of pressing up or down buttons, you flick your finger on hour and minute “tumblers,” giving you a sense of direct manipulation, as though the tumblers are physical objects. This has a pleasing feel, but when the novelty wears off it can be frustratingly slow at times, especially with the minute tumbler. FIG. 1 is a screen shot of an Apple iPhone time setter.

The prior art, through Google's Android® operating system, teaches changing the hours and minutes with plus and minus keys or showing a standard numeric keypad by a single or double touch directly on the hours or minutes. FIG. 2 is a screen shot of such a prior art time setting widget (21), after a double touch on the hour number to display the transitory standard numeric keypad (22). This doesn't have the direct manipulation feel of the Apple iPhone® time setter, but if the keypad is used instead of the plus and minus keys, setting the time is a determinate number of touches rather than some indeterminate number of user actions. Using the keypad, it can take seven or even eight touches to set the time: a double touch in the hour field to select the field and display the keypad (alternatively a single touch in the hour field followed by one or two backspaces to clear the field), two for hour digits, or one and “Next”, to enter the hour, then two for the minute digits, followed by a selection of AM/PM if 12-hour time is being used and the AM/PM value needs to be changed, and finally “Done” (which replaces “Next” after the hour has been entered), to remove the keypad.

The iPhone® made its debut in 2007, and Android® first appeared in a product in 2008, yet there has been little movement in improving the usability of time entry methods. In fact, the extremely competitive mobile-device market has been unable to provide adequate solutions for time entry on touch screens until the current invention. Thus there has existed a long-felt need for a fast, efficient, and simple way to enter a time onto a touch screen device such as a mobile phone, tablet, or wearable device.

### SUMMARY OF THE INVENTION

The current disclosure provides a system and method of inputting time on an electronic device having a touch screen comprising a computer system that displays a graphical hour keypad and detects user touch input to select an hour from the keypad, and displays a graphical minute keypad and detects user touch to select a minute from the keypad. The hour and minute keypads can be shown simultaneously, or sequentially in either order. If shown sequentially, after a selection is made from the first keypad, the system displays the second keypad automatically. The keypads can be embedded in the display of a screen, or can be displayed as needed, in a transitory fashion, as with the slide-up alphanumeric keyboards used on smartphones that lack a physical keyboard. The keypads can be any shape, including, without limitation: rectangular, circular, pie shaped, diamond shaped, and elliptical.

An advantage of the current disclosure over the prior art is that it requires fewer user actions. If transitory keypads are used, just three touches are required if the minute is a multiple of five: one to show the hour keypad, one to select an hour, and one to select a minute, as depicted in FIG. 14, or alternatively one touch to show the hour keypad and one slide gesture to select both the hour and minute, as shown in FIG. 17. If the minute is not a multiple of five, one or two additional user actions may be required. If two 12-key hour sub-keypads are used (most likely only for small-screen devices), one more user action is required when the desired sub-keypad is not currently shown. If at least one of the keypads is non-transitory, one less touch is required. The iPhone style time setter, as shown in FIG. 1, requires an indeterminate number of flicking gestures, and it is easy to go past the desired value thereby requiring a user to backtrack. For the Android style time setter, as shown in FIG. 2, if the plus and minus keys are used, the number of touches is again indeterminate. If the standard numeric keypad is used, it can take seven or even eight touches to set the time, even if the minutes value is a multiple of five, as described above.

Another advantage of the current disclosure over the prior art is that it can be used on small screens such as those found on wearable devices. The Apple and Android time setters are too large and complex for small screens. Some of the embodiments of the current disclosure require no more than 12 keys showing at a given time.

Yet another advantage of the current disclosure over the prior art is that the time setter itself takes up much less screen space if transitory keypads are used. In FIGS. 1 and 2, there is a considerable amount of screen space used by the iPhone and Android style time setters, even when the time is not being set. The current time setting input system and method, on the other hand, allows a time setter to be the same size as a short text field when transitory keypads are used and the time is not being set. FIG. 14 shows an example of a time setter using the invention in the transitory-keypad case. When the time is not being set, the visible portion of the time setter is just the time field (121).

It is an object of the invention to provide a method for setting a time using just a few user actions.

It is another object of the invention to provide a system for quickly and efficiently entering a time.

It is yet another object of the invention to provide a method for setting a time conveniently on small screens such as those found on wearable devices.

As used herein, the term “keypad” means a grouping of keys with each key having a different function or value.

The term “touch event” means user interaction or input through a touch screen, such as when a user touches the touch screen with a finger, including, without limitation, a touch down event, a touch up event, a long touch, a hard press, a touch in place event, a slide event or gesture, a movement event, or a pull event. Furthermore, the method of processing a touch event includes the step of detecting a touch event.

The term “touch down event” means user interaction or input that is executed when a user first makes contact with the touch screen.

The term “touch up event” means user interaction or input that is executed when a user ends contact with the touch screen.

The term “long touch” means a touch event for which the user keeps his or her finger on a key for a predetermined amount of time, regardless of whether the user touched down in that key.

The term “hard press” means a touch event in a key on a touch screen capable of detecting the pressure of a touch, where the pressure exceeds a predetermined threshold, regardless of whether the user touched down in that key.

The term “touch in place event” means a touch event within a single key on the touch screen, with the user's finger touching the screen for the duration of the event. Touch in place events include, without limitation, long touch and hard press events.

The term “slide event” means user interaction or input that is executed when a user moves his or her position of contact on the touch screen, such as when a user moves his or her finger from one position on the touch screen to another position on the touch screen while maintaining contact with the touch screen.

The term “slide gesture” means user interaction or input including a touch down event or a touch in place event, followed by one or more slide events, and completed by a touch up event or a touch in place event.

The term “movement event” means user interaction or input that is executed when a user moves the touch position while maintaining contact with the touch screen. It includes slide events as well as other finger movements such as a roll.

The term “pull event” means user interaction or input that is executed when a user pulls or pushes her finger laterally with respect to the touch screen, such that the friction between the finger and touch screen substantially prevents the finger from sliding, and the touch screen is able to detect the force and direction of the pull or push.

The term “graphical widget” means a component of a graphical user interface (“GUI”), such as a switch, button, or toggle.

The term “time field” means an area of the touch screen where time is displayed, usually digitally, as visual feedback to guide the user when selecting the time, and to display the selected time. The time field may be touch sensitive if a user touch event is required to display the hour or minute keypad.

The term “time setter” means a graphical widget allowing a user to enter a time of day. A time setter may or may not include a time field.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases may be absent. Additionally, the various embodiments set forth herein are described in terms of exemplary block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

One embodiment of the invention comprises displaying an hour keypad, processing one or more touch events to select an hour from that keypad, then automatically displaying a minute keypad, and processing one or more touch events to select a minute from that keypad. Another embodiment reverses the order of hour and minute selection. A further embodiment displays both the hour and minute keypads at the same time and processes a touch event on each keypad to select an hour and minute, in either order. These embodiments can have variations that include, without limitation, the permutations of the embodiments of the hour keypad and embodiments of the minute keypad described herein.

Another embodiment of the invention allows the user, in addition to being able to enter a complete time value, to modify a time value by changing either the hour or minute. The user selects whether to modify the hour or minute, the system displays the appropriate keypad, and processes one or more touch events to select a new value for the hour or minute.

One embodiment of the hour keypad comprises 24 keys, one for each hour in a day, regardless of whether the time format being used is 12-hour or 24-hour. An advantage of the 24-key keypad is that the user can enter both the hour and AM/PM values in a single touch. This removes the need for an AM/PM switch.

Another embodiment of the hour keypad comprises two 12-key sub-keypads, displayed at the same time, with the keypads representing non-overlapping 12-hour contiguous periods in the day. This embodiment can be used regardless of whether the time format being used is 12-hour or 24-hour.

Yet another embodiment of the hour keypad comprises two 12-key sub-keypads as discussed above, except that they are not wholly displayed at the same time, and the system provides the user a means of choosing which sub-keypad is currently displayed, where the means may be a graphical widget, a slide gesture, or other equivalent means. The choice of which of the 12-key sub-keypads is displayed can be persistent (remembered) from one time selection to the next. This embodiment is more suited to smaller screens, such as those found in wearable devices, where displaying 24 keys at a time is not practicable.

One embodiment of the minute keypad comprises 60 keys, one for each minute in an hour.

Another embodiment of the minute keypad comprises 12 keys, one for each multiple of five minutes in an hour.

An additional embodiment of the minute keypad comprises both a 12-key and 60-key keypad, where each key of the 12-key keypad corresponds to a multiple of five minutes in an hour, and each key of the 60-key keypad corresponds to a minute in an hour. If the 12-key and 60-key keypads are not wholly displayed at the same time, the system provides the user a means of choosing which keypad is currently displayed, where the means may be a graphical widget, a slide gesture, or other equivalent means. The choice of which of the 12-key or 60-key keypads is displayed can be persistent from one time selection to the next.

A further embodiment of the minute keypad comprises a 12-key keypad, as well as a standard 10-digit keypad, for entering a minute value that is not a multiple of five, one digit at a time. If the 12-key and 10-digit minute keypads are not displayed at the same time, the system provides the user a means of choosing which keypad is currently displayed, where the means may be a graphical widget, a slide gesture, or other equivalent means. The choice of which of the 12-key or 10-digit minute keypads is displayed can be persistent from one time selection to the next.

Yet another embodiment of the minute keypad is the 12-key keypad, with a method of entering a minute value that is not a multiple of five, the method comprising: processing a touch down or touch in place event on the 12-key minute keypad to select a minute value that is a multiple of five and establish an initial position; processing one or more movement events, where for each movement event, the direction and distance from the touch position at the end of the event relative to the initial position is used to calculate an offset of minutes; for each movement event, combining the minute value with the offset of minutes to generate a revised minute value and display it in a time field; and processing a touch up event to select the revised minute value. The offset of minutes can be positive or negative.

A further embodiment of the minute keypad is the 12-key keypad, with a method of entering a minute value that is not a multiple of five, the method comprising: processing a touch down or touch in place event on the 12-key minute keypad to select a minute value that is a multiple of five; processing one or more pull events, where for each pull event, the direction and force of the event is used to calculate an offset of minutes; for each pull event, combining the minute value with the offset of minutes to generate a revised minute value and display it in a time field; and processing a touch up event to select the revised minute value. The offset of minutes can be positive or negative.

Yet a further embodiment of the minute keypad is the 12-key keypad, with the system providing a method of selecting a minute value that is not a multiple of five, by being able to detect an optional touch in place event to select an initial minute value that is a multiple of five, and then to display a sub-keypad containing minutes that are not a multiple of five and that are also near the initial minute value. At least one of the minute values in the sub-keypad is one minute less than or one minute more than the initial minute value. The sub-keypad may or may not contain the initial minute value. The system then processes a subsequent touch event (touch down event, touch up event, or touch in place event) on the sub-keypad to select a final minute value.

In addition to variations created by permutations of the hour and minute keypad embodiments, there can be several ways in which keys can be selected, which include, without limitation: selecting the first key to be touched (touch down event), with the possible restriction that the touch up event occur in the same key; selecting the last key to be touched (touch up event), which allows the user to slide his or her finger in order to correct touching down on a key that is not the desired one; selecting a key via one or more movement events that don't necessarily occur within the keypad, where the keypad and/or a time field provide visual feedback; selecting a key via one or more pull events that don't necessarily occur within the keypad, where the keypad and/or a time field provides visual feedback; and allowing the user to select both hour and minute values with a slide gesture via the following: processing a touch event that is either a touch down event or a touch in place event in a key of the hour keypad and using that value as an hour selection; wherein, if the hour and minute keypads are not wholly displayed at the same time, displaying a minute keypad while a user is still touching the touch screen display from the touch event on the hour keypad; wherein processing one or more touch events to obtain a value from the minute keypad comprises detecting a slide event to a key on the minute keypad and detecting a touch up event in a key of the minute keypad and using that value as a minute selection (see, for example, FIG. 17, FIG. 18, and FIG. 19 with their associated discussions below).

A particular embodiment of the current disclosure includes a device comprising a touch screen display, a processor, memory, and one or more software programs, where the software programs are stored within the memory and are executed by the processor, and where the software programs include instructions for: displaying an hour keypad on the touch screen display; processing one or more touch events on the touch screen display to obtain a value from the hour keypad and using that value as an hour selection; displaying a minute keypad on the touch screen display; and processing one or more touch events on the touch screen display to obtain a value from the minute keypad and using that value as a minute selection. Alternatively, the minute keypad is displayed before the hour keypad, or the hour keypad and minute keypads are displayed at the same time. One or both of the hour and minute keypads may be displayed in a transitory fashion, as needed. The hour keypad comprises twenty-four keys, where each key corresponds to an hour of a day. Alternatively, the hour keypad comprises two sub-keypads, each with twelve keys, where each key corresponds to an hour of a day. The two sub-keypads of the hour keypad may or may not be wholly displayed at the same time. If not, the software programs further include instructions for displaying a graphical widget, where the graphical widget enables a user to select which sub-keypad of the hour keypad is displayed, or the software programs may further include instructions for processing a slide gesture, where the slide gesture enables a user to select which sub-keypad of the hour keypad is displayed. The minute keypad comprises sixty keys, where each key of the minute keypad corresponds to a minute of an hour; or the minute keypad comprises both a twelve-key keypad and a sixty-key keypad, where each key of the twelve-key keypad corresponds to a multiple of five minutes of an hour, and each key of the sixty-key keypad corresponds to a minute of an hour. The twelve-key and the sixty-key minute keypads may or may not be wholly displayed at the same time. If not, the software programs may further include instructions for displaying a graphical widget, where the graphical widget enables a user to select whether the twelve-key or the sixty-key minute keypad is being displayed, or the software programs may further include instructions for processing a slide gesture, where the slide gesture enables a user to select whether the twelve-key or the sixty-key minute keypad is being displayed. In an alternative method for selecting the hour and minute, in which both hour and minute values are selected with a single slide gesture, the instructions for processing one or more touch events to obtain a value from the hour keypad comprise processing a touch down event or a touch in place event in a key of the hour keypad and using that value as the hour selection; if the minute keypad is not already displayed, the minute keypad is displayed while a user is still touching the touch screen display following the processing of the touch event in a key of the hour keypad; the instructions for processing one or more touch events to obtain a value from the minute keypad comprise processing a slide event to a key on the minute keypad; and processing a touch up event in a key of the minute keypad and using the value of that key as the minute selection.

Another embodiment of the current disclosure includes a device comprising a touch screen display; and a processor executing programming logic for interfacing with the touch screen display; the programming logic configured to display an hour keypad on the touch screen display; process one or more touch events to obtain a value from the hour keypad and use that value as an hour selection; display a minute keypad on the touch screen display; process one or more touch events to obtain a value from the minute keypad and use that value as a minute selection; wherein the minute keypad comprises twelve keys, where each key corresponds to a multiple of five minutes of an hour. The programming logic may be further configured to display a ten-digit keypad, where the ten-digit keypad allows the user to specify a minute value that is not a multiple of five minutes, one digit at a time. The twelve-key minute keypad and the ten-digit minute keypad may or may not be displayed at the same time. If not, the programming logic may be further configured to display a graphical widget, where the graphical widget enables a user to select whether the twelve-key or the ten-digit minute keypad is displayed, or the programming logic may be further configured to process a slide gesture, where the slide gesture enables a user to select whether the twelve-key or the ten-digit minute keypad is displayed. If the ten-digit minute keypad is not used, in order to allow selection of a minute value that is not a multiple of five, the programming logic may be configured to process a touch down or touch in place event to obtain a value from the minute keypad; process one or more movement events, where an offset of minutes is calculated for each movement event using a distance and direction of relative movement of touch position over the touch screen display; combine the minute value with the offset of minutes for each movement event to generate revised minute values; display the revised minute value for each movement event; and process a touch up event to select the currently-displayed revised minute value. In yet another means of selecting a minute value that is not a multiple of five, the programming logic is configured to process a touch in place event to obtain an initial value from the minute keypad; display a minute sub-keypad containing minute values that are not multiples of five, where at least one of the minute values is one more or one less than the initial minute value; and process a subsequent touch event on the sub-keypad to select a final minute value. The minute sub-keypad may include a key having the initial minute value.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects, and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 shows a prior art Apple® iPhone® time setter.

FIG. 2 shows a prior art Android® time setter.

FIG. 3 shows a 24-key hour keypad, with 12-hour time, according to selected embodiments of the current disclosure.

FIG. 4 shows a 24-key hour keypad, with 24-hour time, according to selected embodiments of the current disclosure.

FIG. 5 shows a 24-key hour keypad comprising two 12-key sub-keypads, according to selected embodiments of the current disclosure.

FIG. 6 shows a transition between two 12-key hour sub-keypads, according to selected embodiments of the current disclosure.

FIG. 7 shows a 60-key minute keypad, according to selected embodiments of the current disclosure.

FIG. 8 shows a 12-key minute keypad, according to selected embodiments of the current disclosure.

FIG. 9 shows a minute keypad selector with 5-minute intervals selected, according to selected embodiments of the current disclosure.

FIG. 10 shows a minute keypad selector with 1-minute intervals selected, according to selected embodiments of the current disclosure.

FIG. 11 shows a transition between a 12-key minute keypad and an additional 10-digit keypad, according to selected embodiments of the current disclosure.

FIG. 12 shows a method of selecting a minute that is not a multiple of five using a 12-key keypad and movement events, according to selected embodiments of the current disclosure.

FIG. 13 shows a method of selecting a minute that is not a multiple of five using a 12-key keypad and a 9-key sub-keypad, and also illustrates how the user can modify a time, with highlighted keys and digital time display feedback, according to selected embodiments of the current disclosure.

FIG. 14 shows a method of selecting a time in which the selected keys are those in which the user touches down in, with highlighted keys and digital time display feedback, according to selected embodiments of the current disclosure.

FIG. 15 shows a corrective-sliding method applied to the hour keypad, and also illustrates the case of a non-transitory hour keypad used with a transitory minute keypad, with highlighted keys and digital time display feedback, according to selected embodiments of the current disclosure.

FIG. 16 shows an example of selecting a minute value using one or more movement events that are not on the minute keypad, with highlighted keys and digital time display feedback, according to selected embodiments of the current disclosure.

FIG. 17 shows a method for selecting both hour and minute with a slide gesture, with highlighted keys and digital time display feedback, according to selected embodiments of the current disclosure.

FIG. 18 shows another example of slide-gesture time selection, with highlighted keys and digital time display feedback, according to selected embodiments of the current disclosure.

FIG. 19 shows a third example of slide-gesture time selection, and also illustrates the case of both hour and minute keypads being non-transitory and shown at the same time, with highlighted keys and digital time display feedback, according to selected embodiments of the current disclosure.

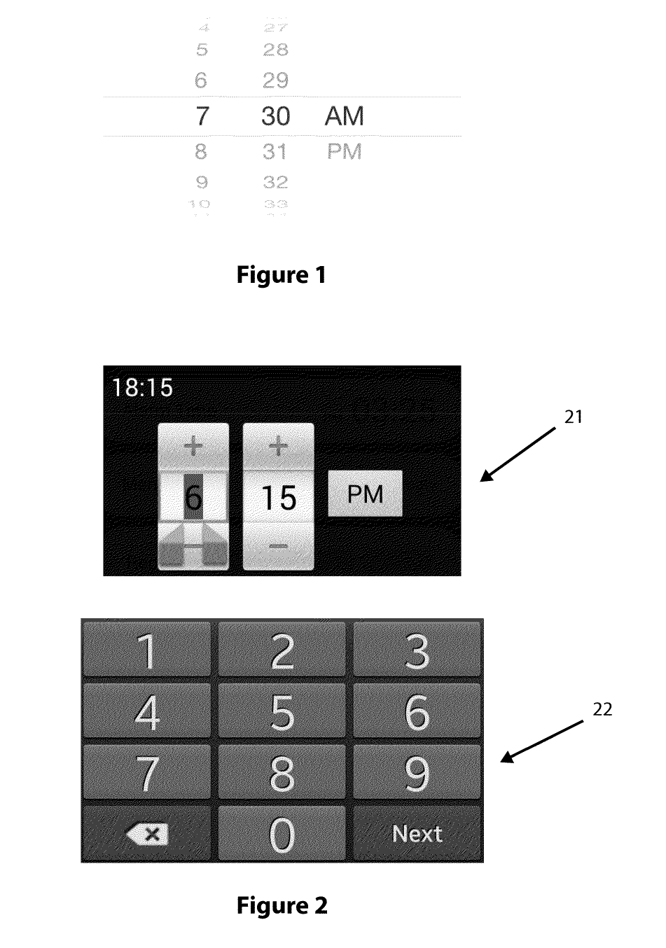

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

According to a selected embodiment, the invention provides for a device having a touch screen showing two touch keypads via a graphical user interface, one to select an hour, and one to select a minute.

The minute and hour keypads do not have to be separated spatially; they could overlap or use the same space, in which case they would be displayed sequentially, including systems and methodologies discussed in more detail below. If the hour and minute keypads are displayed at the same time, the user can select the hour and minute in either order. If the keypads are displayed sequentially, it is likely that the hour keypad would be displayed first, by convention, although displaying the minute keypad first is not precluded. In the sequential case, once an hour or minute is selected from one keypad, the other keypad is shown automatically.

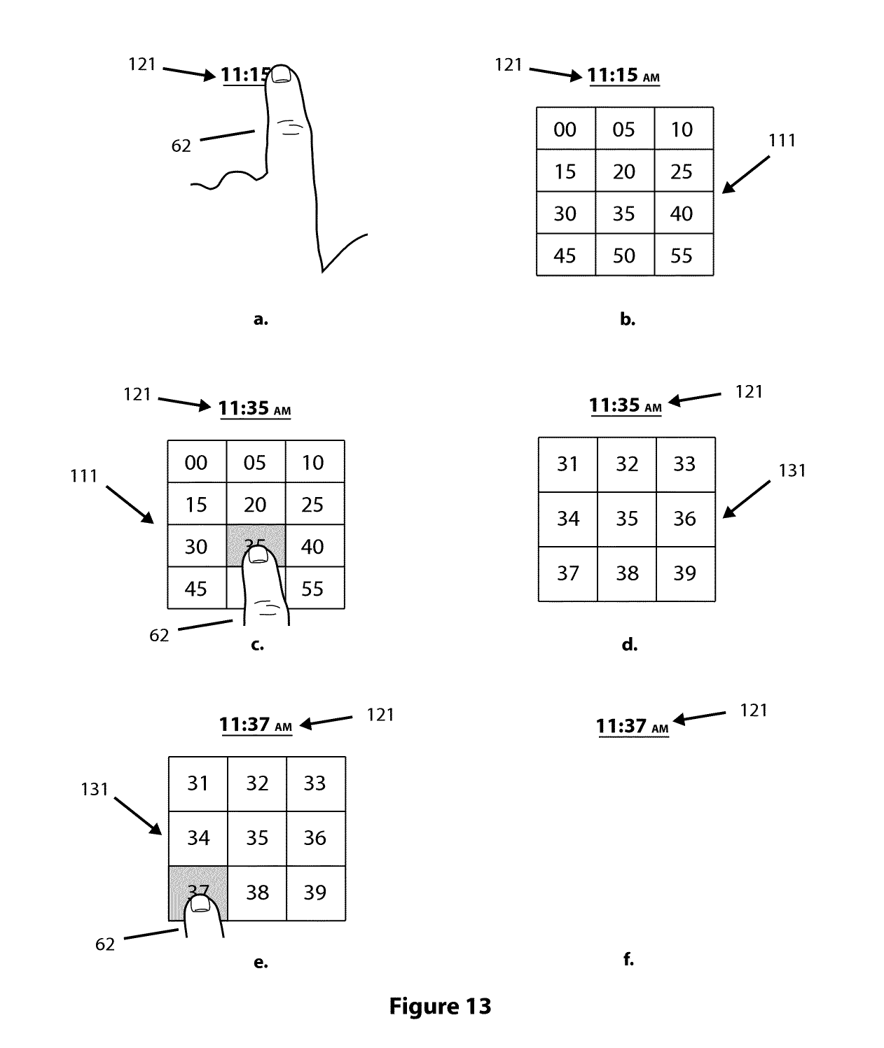

In addition to the system allowing a user to enter a new time value, it can give the user the ability to modify a time value. The user selects whether to modify the hour or minute, the system displays the appropriate keypad, and processes one or more user touch events to select a new value for the hour or minute. An example is given in FIG. 13.

The keypads can be embedded in the display of a single screen, or one or both can be displayed as needed, in a transitory fashion, as with the slide-up alphanumeric keyboards used on smartphones that lack a physical keyboard.

In the figures, the keypads are shown as being rectangular; however other shapes including, without limitation: circular, pie shaped, diamond shaped, and elliptical are contemplated by the current disclosure.

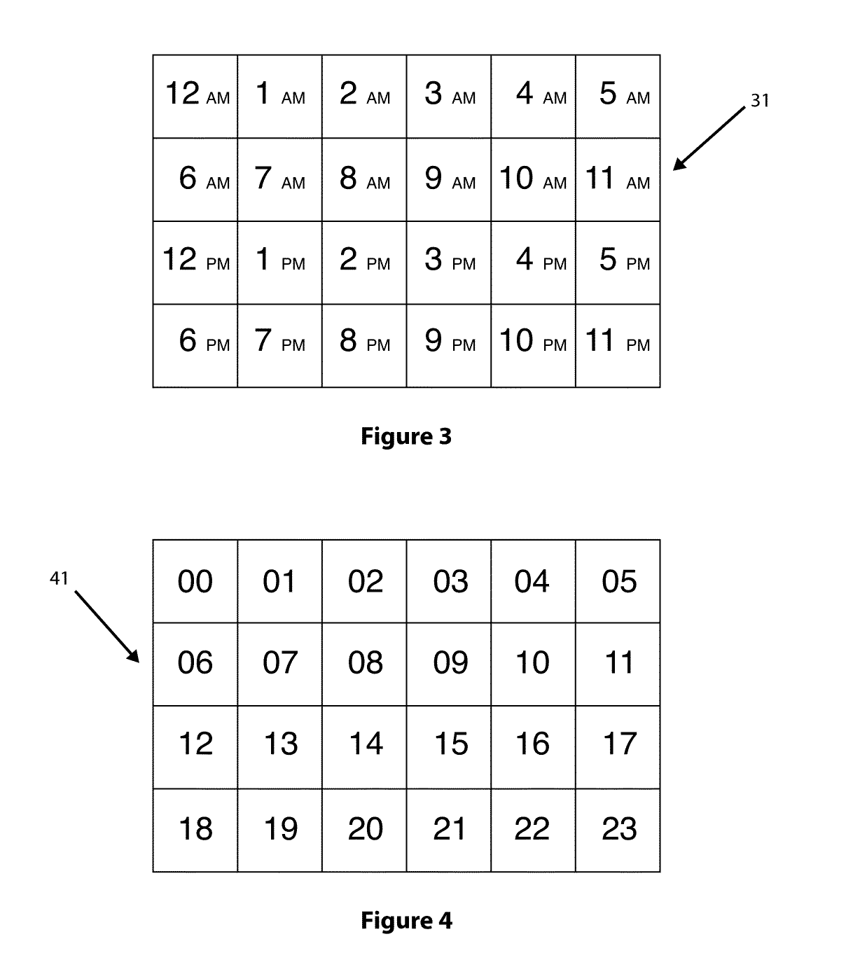

One form of the hour keypad is a 24-key keypad, one for each hour of the day, regardless of whether the time format being used is 12-hour or 24-hour. An advantage of a 24-key keypad over a standard 10-digit keypad or a 12-key keypad is that both the hour value and the AM/PM value can be set with a single touch. FIG. 3 shows an example hour keypad (31) using 12-hour time. FIG. 4 shows an example hour keypad (41) with 24-hour time.

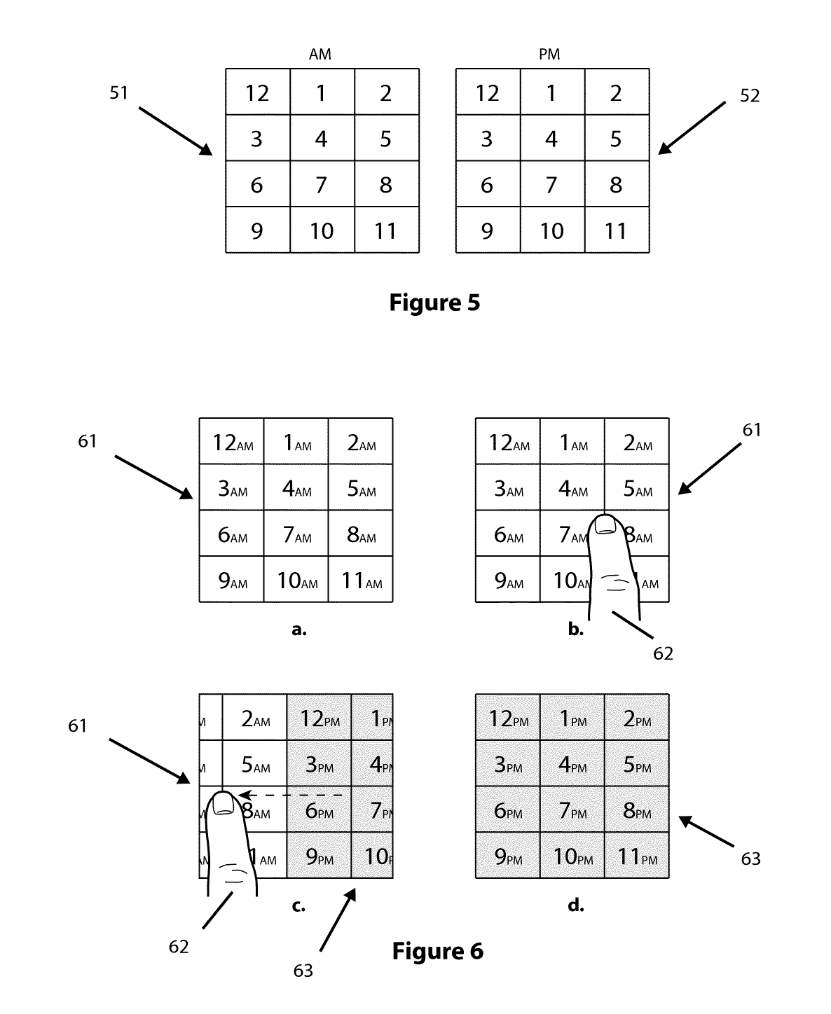

A variation of the 24-hour keypad is a pair of 12-key sub-keypads. FIG. 5 shows an example of the 12-key sub-keypad configuration with both sub-keypads shown at the same time. In the example, the 12-key sub-keypad (51) is for AM hours, while the other 12-key sub-keypad (52) is for PM hours. The division of keys between the keypads does not have to be between AM and PM hours; any two non-overlapping contiguous groups of 12 hours could be used. Two 12-key sub-keypads can be used regardless of whether the time format being used is 12-hour or 24-hour.

In order to accommodate the much smaller screens of the new class of wearable devices, it is likely that showing 24 keys at once would not be desirable. In this case, two 12-key sub-keypads may be used, with only one shown at a time. FIG. 6 shows an example of the one-sub-keypad-at-a-time case in which the user slides her finger (62) to change the display from AM hours (61) to PM hours (63). The division of keys between the keypads does not have to be between AM and PM; any two non-overlapping contiguous groups of 12 hours can be used. Alternatives to the slide gesture include, without limitation, a graphical widget. The user choice of sub-keypad can be persistent from one time selection to the next.

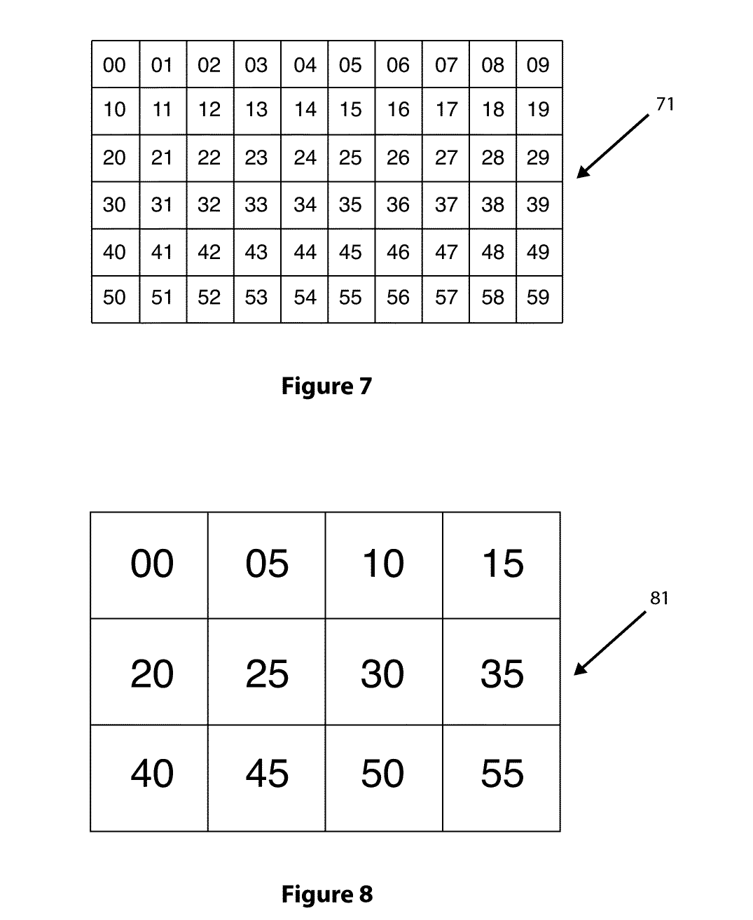

The minute keypad can also take different forms, including a 60-key form and/or a 12-key form. FIG. 7 shows an example of a 60-key keypad (71), with one key for each minute in an hour. FIG. 8 shows an example minute keypad (81) containing 12 keys, one for each multiple of five minutes in an hour. The advantage of the 60-key keypad is that the input has one-minute accuracy instead of five. The advantage of using the 12-key keypad is that the keys are larger, and most day-to-day uses of setting time, such as for alarms and appointment/reminder times, are sufficiently covered using five-minute increments.

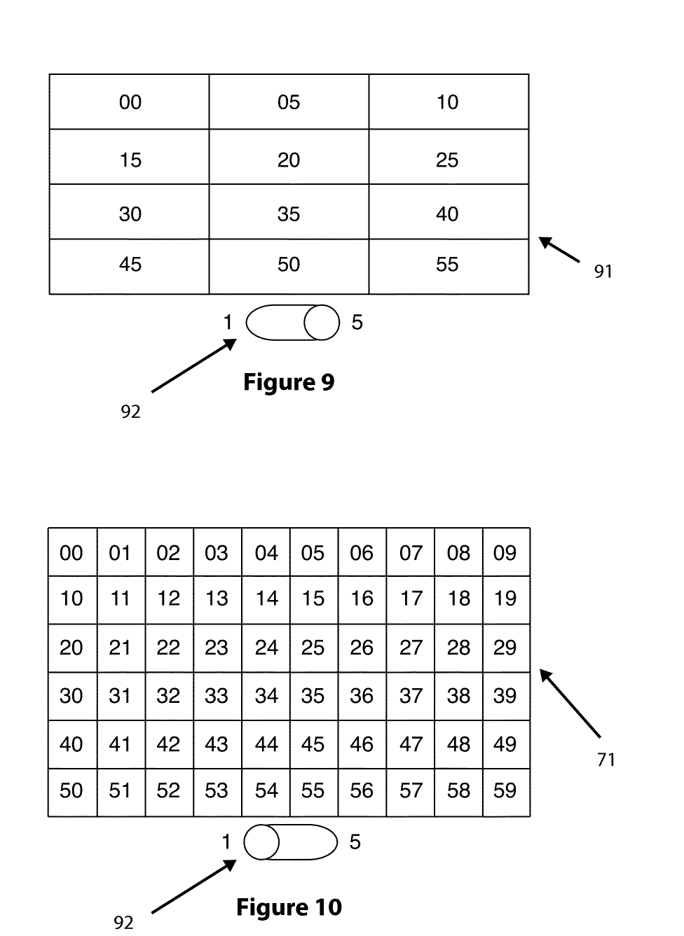

An additional embodiment of the minute keypad comprises both a 12-key and 60-key keypad, where each key of the 12-key keypad corresponds to a multiple of five minutes in an hour, and each key of the 60-key keypad corresponds to a minute in an hour. If the 12-key keypad and the 60-minute keypad are not wholly displayed at the same time, the device can provide a graphical widget to let the user switch between the two. FIGS. 9 and 10 show examples in which a widget (92) is placed directly below the minute keypad, where FIG. 9 shows the widget set to multiples of 5 minutes, which displays the 12-key minute keypad (91), and FIG. 10 shows the widget set to multiples of 1 minute, which displays the 60-key minute keypad (71). Alternatives to the widget include, without limitation, a slide gesture. The user choice of minute keypad can be persistent from one time selection to the next.

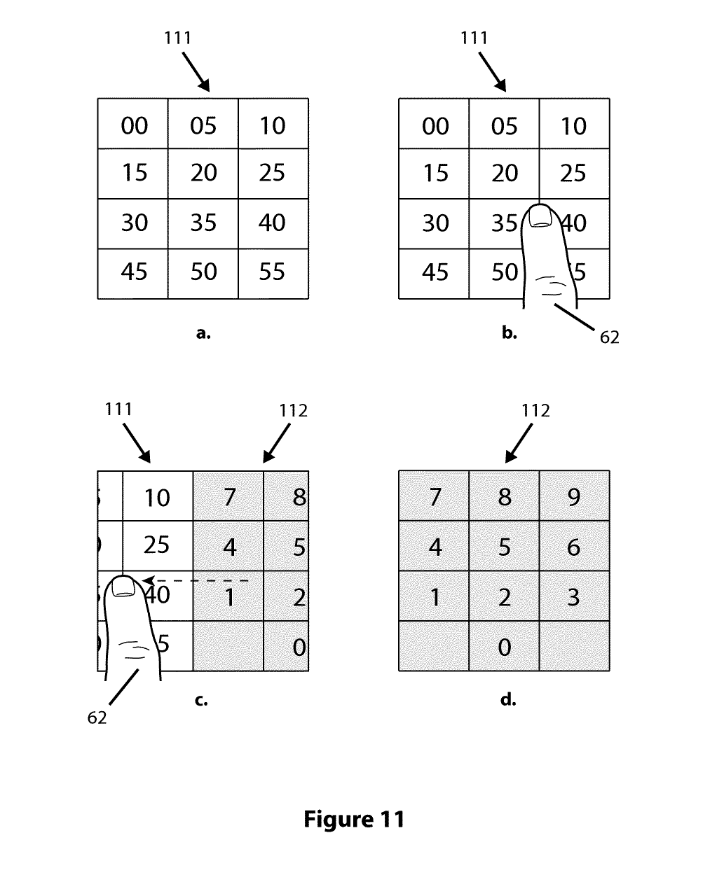

Particular embodiments of the current disclosure use a 12-key minute keypad, in conjunction with a standard 10-digit numeric keypad that allows the user to select a minute that is not a multiple of five, one digit at a time. FIG. 11 shows an example of the case in which a 12-key minute keypad (111) is used with a 10-digit numeric keypad (112), and the two keypads aren't displayed at the same time. In the example, the user employs a slide gesture with her finger (62) to switch from displaying the 12-key keypad (111) to the 10-digit keypad (112). Alternatives to the slide gesture include, without limitation, a graphical widget. The user choice of 12-key or 10-digit minute keypad can be persistent from one time selection to the next.

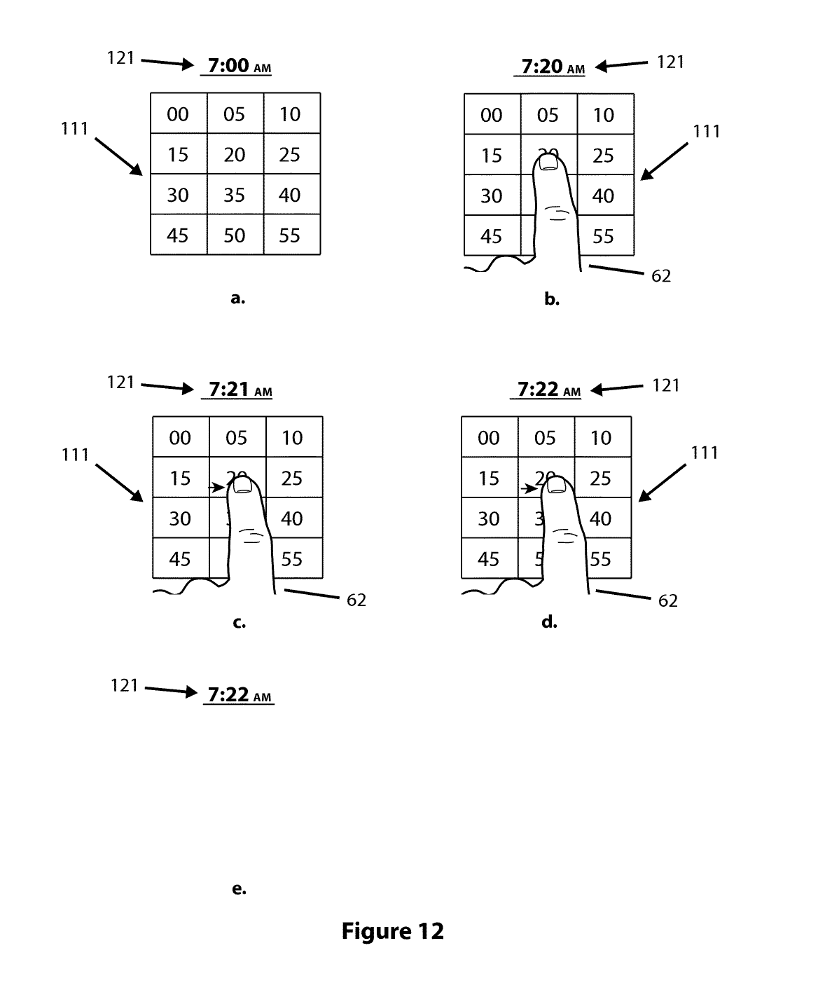

In another way in which a minute that is not a multiple of five can be selected with a 12-key keypad, the user selects a minute by an initial touch event in a key whose value is a nearest multiple of five minutes greater or less than the desired value, then selects the desired minute using one or more movement or pull events. Each event's direction and magnitude, where the magnitude of a movement event is the distance from the initial touch event, and the magnitude of a pull event is the force of the pull, are used to calculate a positive or negative offset of minutes. A time field provides visual feedback of the initial value plus the offset, and the user selects a displayed value by lifting her finger. An example of this is depicted in FIG. 12, assuming that the hour “7:00 AM” has already been selected via the hour keypad. FIG. 12a shows a minute keypad (111) having multiples of five minutes, with a time field above it (121) showing the selected hour. FIG. 12b shows a user's finger (62) selecting the “20” key using a touch down event, with the time of “7:20 AM” displayed in the time field (121). FIG. 12c shows the user sliding her finger (62) (a movement event) to the right to increase the time by one minute, with “7:21 AM” displayed in the time field (121). FIG. 12d shows the user sliding her finger (62) further to the right (continuing a movement event or a subsequent movement event) to increase the time by one minute, with “7:22 AM” displayed in the time field (121). When the user lifts her finger from the screen (a touch up event), the selected time of “7:22 AM” continues to be displayed in the time field (121), and the minute keypad is removed, as shown in FIG. 12e.

Yet another way in which a minute that is not a multiple of five can be selected with a 12-key keypad is to use a sub-keypad. With this form, the user selects an exact minute via a touch in place event on a key whose value is a multiple of five minutes near the desired value. The device then displays a sub-keypad with key values to the nearest minute in the neighborhood of the selected multiple of five minutes. Depending on the implementation, the user can then lift her finger and touch the desired key on the sub-keypad, or slide her finger to the desired key and lift. An example of this form of interaction is shown in FIG. 13, which is also an example of allowing the user to modify a time. FIG. 13a shows the time field showing a current time of “11:15 AM”, and the user touching the minute portion of the time field to indicate that the minute value is to be modified. FIG. 13b shows a 12-key minute keypad (111) having multiples of five minutes, beneath the time field (121) still showing the current time. FIG. 13c shows a user creating a touch in place event (for example long touch or hard press) in the “35” key, and the system displaying “35” in the minute portion of the time field (121). FIG. 13d shows the sub-keypad (131), which includes the “35” key now surrounded by eight keys, four of which represent four previous minutes and the other four represent four minutes after the “35” minute. Note that in this example, the user is able to release her finger from the screen, and the sub-keypad (131) remains displayed. FIG. 13e shows the user selecting, by a touch down event, the “37” key of the sub-keypad (131). Upon touch down, the time field (121) is updated to show “11:37 AM”. When the user lifts her finger from the screen (a touch up event), the updated time of “11:37 AM” continues to be displayed in the time field (121), and the minute keypad is removed, as shown in FIG. 13f.

The nine-key sub-keypad of FIG. 13, in which the keys represent the four contiguous minutes less than the initial value, the initial value, and the four contiguous minutes greater than the initial value, is just one of a number of possible sub-keypad configurations. Others include, without limitation: a four-key keypad whose values are the four contiguous minutes greater than the initial selection; a five-key keypad like the previous but including the initial selection; a nine-key keypad whose values are the nine contiguous minutes after the initial value if that value is a multiple of ten, or the initial value minus five minutes if that value is not a multiple of ten; and a ten-key keypad like the previous but containing the initial selection if it is a multiple of ten.

Following are descriptions of forms of interacting with the hour and minute keypads. This is not meant to be an exhaustive list, and the forms are not mutually exclusive.

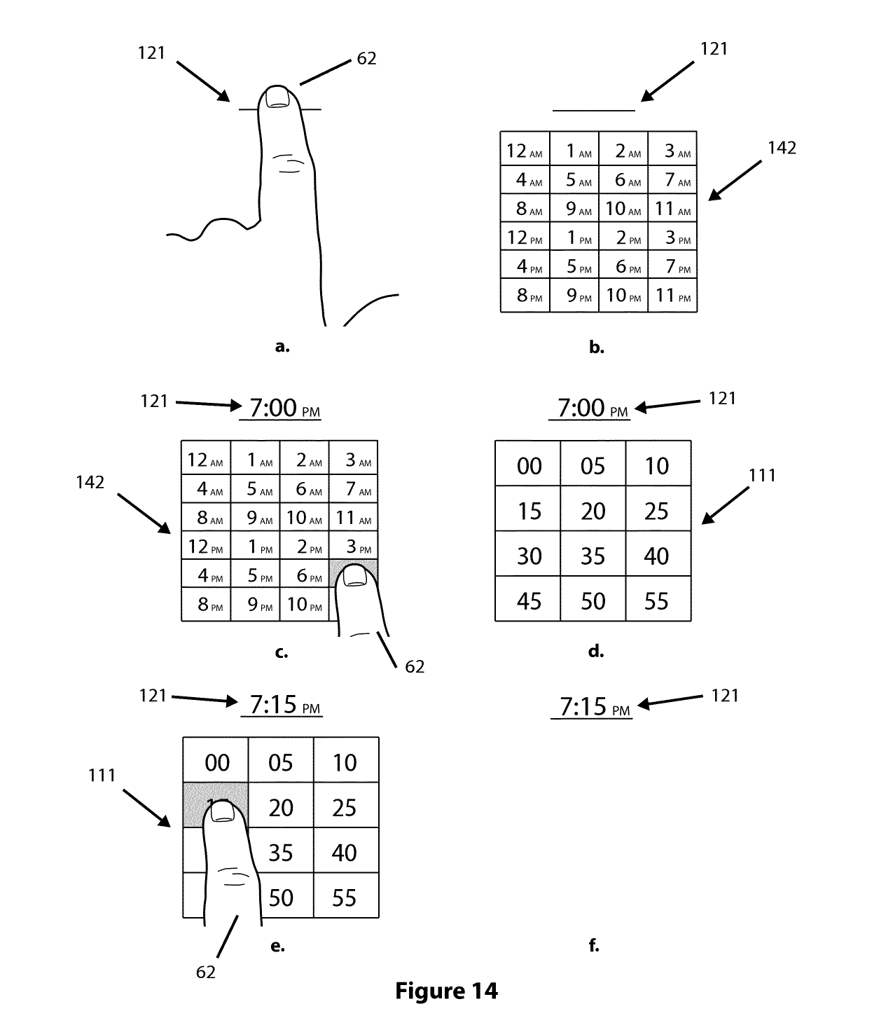

One form of interaction would be to use touch down events to select the hour and minute. For example, the device displays an hour keypad, and uses the value of the hour key that first incurs a touch down event. The device then displays the minute keypad, if the hour and minute keypads are displayed sequentially, and the device uses the value of the minute key that first incurs a touch down event. For both the hour and minute selection, the system could have the additional restriction that the touch up event is in the same key in which the touch down occurred. FIG. 14 shows an example of an entire sequence of touches to set a time when the display of both keypads is transitory. FIG. 14a shows the user touching the time field (121) to cause the hour keypad to be displayed. FIG. 14b shows the 24-key hour keypad (142) after the user has lifted her finger. FIG. 14c shows the user selecting the “7 PM” key on the hour keypad (142) with her finger (62), with the time field (121) updated to display “7:00 PM”. The system then automatically transitions to display the 12-key minute keypad (111), as shown in FIG. 14d. In FIG. 14e, the user selects the “15” minute key, and the time field is updated to display “7:15 PM”. Upon selection, the system automatically removes the minute keypad, and the time field (121) continues to display the selected time of “7:15 PM”, as shown in FIG. 14f.

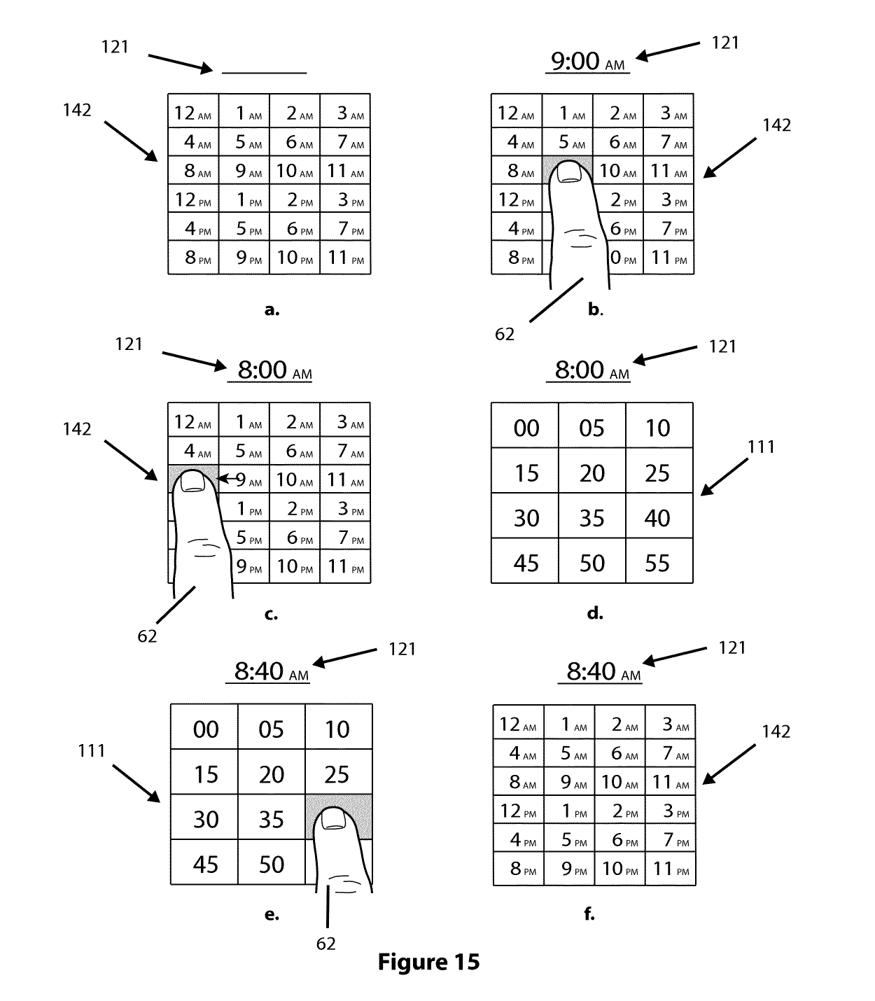

Another form of interaction uses corrective sliding. This form delays selection until the user lifts her finger (a touch up event), allowing her to correct touching down in the wrong key by letting her slide her finger to the desired key, and lift up to select the desired value. To aid the user, when the user's finger is on a key, from either a touch or slide, the device can highlight the key and/or display the value of the key in a time field. An example of correcting an undesired value on the hour keypad is depicted in FIG. 15, which also illustrates the case of a non-transitory hour keypad used with a transitory minute keypad. FIG. 15a shows the time field (121) with the non-transitory hour keypad (142), which is displayed unless covered by the minute keypad. Together the time field and hour keypad make up the time setter when not in use. FIG. 15b shows the user's finger (62) touching down on the “9 AM” key, with the time field (121) updated to show “9:00 AM”. FIG. 15c shows the user sliding her finger (62) from the “9 AM” key to the “8 AM” key to correct the hour value, with the time field (121) now showing “8:00 AM”. FIG. 15d shows the display after the user lifts her finger from the hour keypad; the minute keypad (111) is displayed automatically. FIG. 15e shows the user touching the “40” key on the minute keypad (111), with the time field (121) now showing “8:40 AM”. FIG. 15f shows the selected time of “8:40 AM” continuing to be shown in the time field (121) after the user lifts her finger from the minute keypad, with the minute keypad automatically removed and the non-transitory hour keypad (142) showing again. Corrective sliding can be used with either transitory or non-transitory keypads, and with either hour or minute keypads.

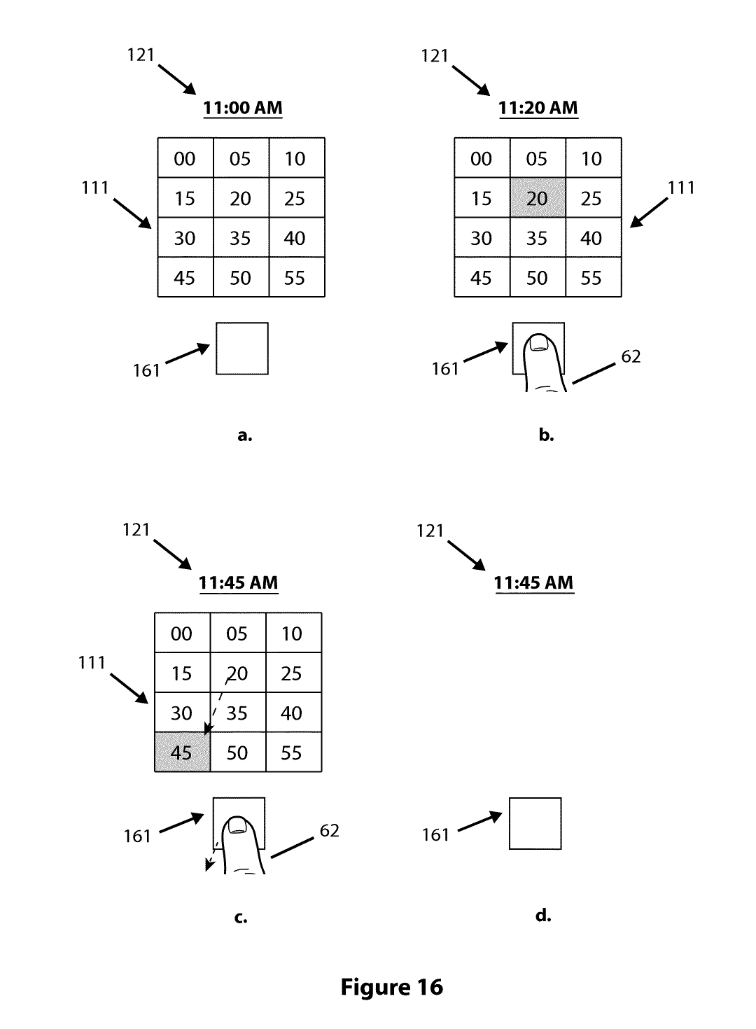

In an additional form of user interaction, a value is selected via one or more movement events that don't necessarily occur within the keypad, where the keypad and/or a time field provide visual feedback. FIG. 16 depicts an example of this type of interaction in the selection of a minute value after the user has already selected “11:00 AM” as the hour. FIG. 16a shows a 12-key minute keypad (111), with “11:00 AM” showing in the time field (121), and with a touch box (161) below it. In FIG. 16b, the user places her finger (62) in the touch box (161), causing the “20” key, whose relative position within the keypad (111) corresponds to the relative touch position within the touch box (161), to be highlighted, and the time field (121) to contain “11:20 AM”. In FIG. 16c, the user moves her finger (62) at roughly the same angle as between the “20” key and the “45” key, causing the “45” key to be highlighted, and the time field (121) to contain “11:45 AM”. The “30” and/or “35” key may have been highlighted between the highlighting of the “20” and “45” keys. In FIG. 16d the time field (121) continues to show the selected time of “11:45 AM” after the user has lifted her finger from the touch input box (161).

If the touch screen is able to detect them, pull events could be used to select the hour and/or minute, in a similar manner as for movement events. In the example depicted in FIG. 16, if pull events were used instead of movement events, FIG. 16c would show the user pulling her finger in the desired direction with an amount of force necessary to move the highlighted key in the keypad from the “20” key to the “45” key.

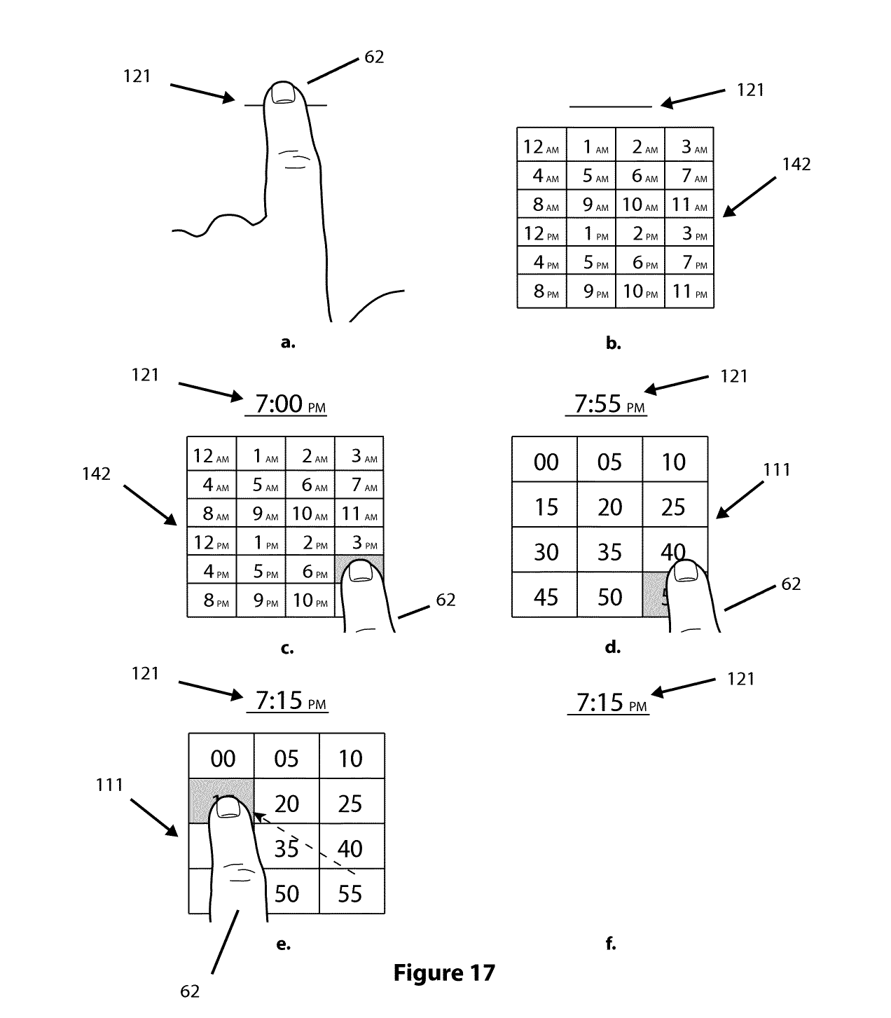

Yet another form of user interaction would be to use a slide gesture to select both an hour and a minute. The user could select the hour by a touch down event or a touch in place event on the desired hour key, sliding her finger to the desired minute key, and then lifting her finger. If the hour and minute keypads were not wholly displayed at the same time, the display of keypads would swap automatically after the touch event in the hour keypad. The selection of hour and minute could be reversed, as mentioned above. An example of this type of interaction is depicted in the transitory keypad example of FIG. 17. FIG. 17a shows the user touching the time field (121) to cause the 24-key hour keypad to be displayed. FIG. 17b shows the hour keypad (142) after the user lifts her finger. FIG. 17c shows the touch down event on the “7 PM” key, with the time field (121) showing “7:00 PM” above the hour keypad (142). FIG. 17d shows the automatic transition to the minute keypad (111), with the user's finger (62) already touching the “55” minute key at the same location where it had previously been touching the “7 PM” key, and the time field (121) showing “7:55 PM” above the minute keypad. FIG. 17e shows the user sliding her finger (62) from the “55” key to the desired “15” key, with the digital display (121) now showing “7:15 PM”. When the user releases her finger the selection of 7:15 PM is complete, as shown in FIG. 17f.

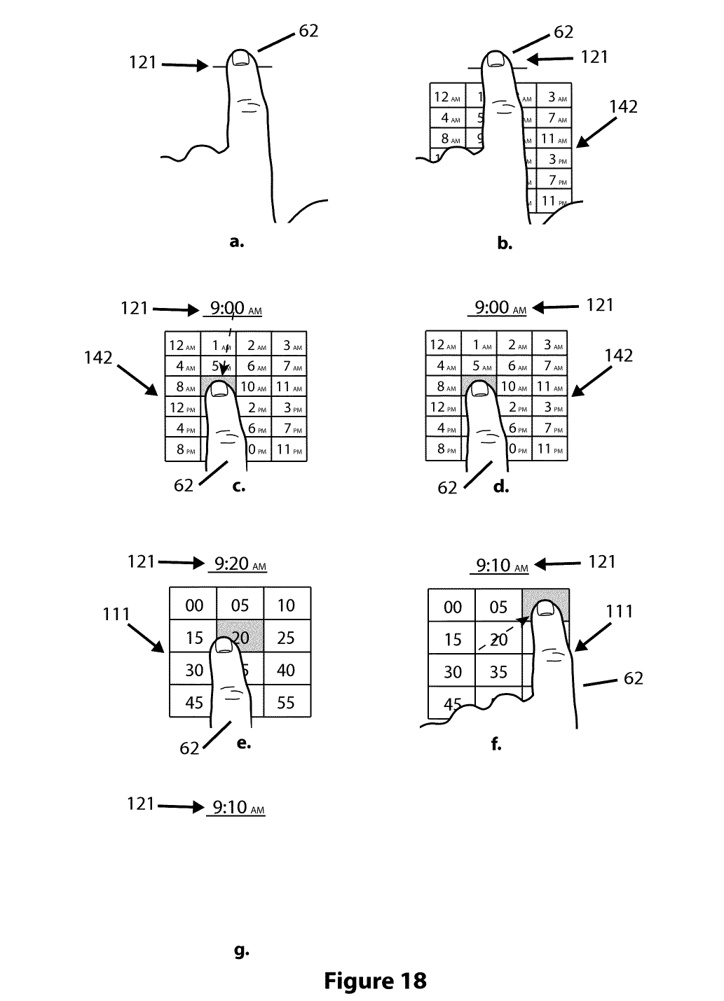

FIG. 18 shows another slide-gesture time selection example with transitory keypads. In this case, the user causes the hour keypad to be displayed and selects the time, all with her finger not leaving the screen, except upon completion. FIG. 18a shows the user touching the time field (121) to cause the hour keypad to be displayed. FIG. 18b shows the displayed hour keypad (142). Instead of lifting her finger (62), the user slides her finger to the “9 AM” key, with the time field (121) showing “9:00 AM” above the hour keypad (142), as shown in FIG. 18c. In FIG. 18d, the user uses a touch in place (for example long touch or hard press) event to confirm the selection of “9 AM”. The minute keypad (111) is then displayed automatically, with the user's finger (62) initially touching the “20” minute key at the same location where it had previously been touching the “9 AM” key, and the time field (121) showing “9:20 AM”, as shown in FIG. 18e. To select a minute value, the user slides her finger (62) to the desired “10” minute key, with the time field (121) now showing “9:10 AM”, as shown in FIG. 18f. The user then lifts her finger, completing both the slide gesture and the selection of the “10” minute key, leaving the selected time of “9:10 AM” in the time field (121), and causing the minute keypad to disappear, as shown in FIG. 18g.

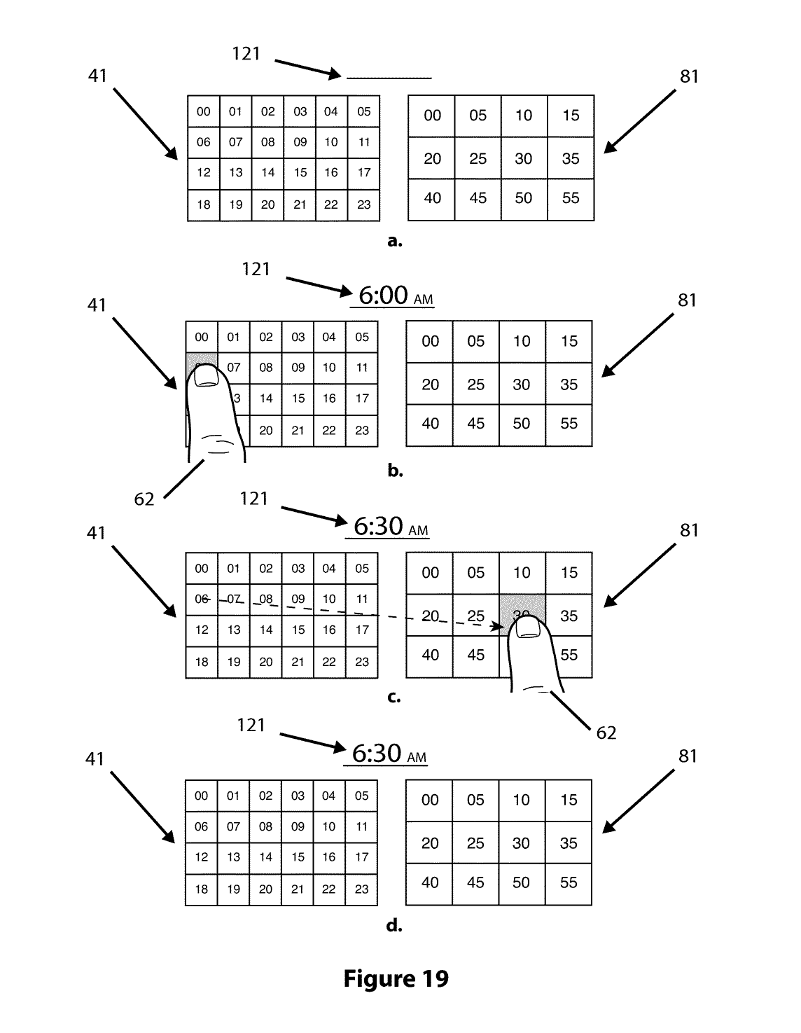

FIG. 19 shows yet another example of slide-gesture time selection, this time with both hour and minute keypads being non-transitory, and shown at the same time. FIG. 19a shows the time field with the hour keypad (41) and minute keypad (81) before any user action. The time field and two keypads make up the time setter, whether in use or not. FIG. 19b shows the user touching the “6 AM” key on the hour keypad (41), with the time field (121) showing “6:00 AM”. The hour value remains unchanged as the user slides her finger (62) to the “30” button on the minute keypad (81), as shown in FIG. 19c. Once the slide is complete, the time field (121) reads “6:30 AM”. This selected time is still displayed in the time field (121), as shown in FIG. 19d, after the user lifts her finger.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

1. A device comprising
a touch screen display, a processor, memory, and one or more software programs, where the software programs are stored within the memory and are executed by the processor, and where the software programs include instructions for:
displaying an hour keypad on the touch screen display;
processing one or more touch events on the touch screen display to obtain a value from the hour keypad and using that value as an hour selection;
displaying a minute keypad on the touch screen display; and
processing one or more touch events on the touch screen display to obtain a value from the minute keypad and using that value as a minute selection.

2. The device of claim 1, wherein the minute keypad is displayed before the hour keypad.

3. The device of claim 1, wherein the hour keypad and minute keypads are displayed at the same time.

4. The device of claim 1, wherein one or both of the hour and minute keypads are displayed in a transitory fashion, as needed.

5. The device of claim 1, wherein the hour keypad comprises twenty-four keys, where each key corresponds to an hour of a day.

6. The device of claim 1, wherein the hour keypad comprises two sub-keypads, each with twelve keys, where each key corresponds to an hour of a day.

7. The device of claim 6, wherein the two sub-keypads of the hour keypad are not wholly displayed at the same time.

8. The device of claim 7, wherein the software programs further include instructions for displaying a graphical widget, where the graphical widget enables a user to select which sub-keypad of the hour keypad is displayed.

9. The device of claim 7, wherein the software programs further include instructions for processing a slide gesture, where the slide gesture enables a user to select which sub-keypad of the hour keypad is displayed.

10. The device of claim 1, wherein the minute keypad comprises sixty keys, where each key of the minute keypad corresponds to a minute of an hour.

11. The device of claim 1, wherein the minute keypad comprises both a twelve-key keypad and a sixty-key keypad, where each key of the twelve-key keypad corresponds to a multiple of five minutes of an hour, and each key of the sixty-key keypad corresponds to a minute of an hour.

12. The device of claim 11, wherein the twelve-key and the sixty-key minute keypads are not wholly displayed at the same time.

13. The device of claim 12, wherein the software programs further include instructions for displaying a graphical widget, where the graphical widget enables a user to select whether the twelve-key or the sixty-key minute keypad is displayed.

14. The device of claim 12, wherein the software programs further include instructions for processing a slide gesture, where the slide gesture enables a user to select whether the twelve-key or the sixty-key minute keypad is displayed.

15. The device of claim 1, wherein the instructions for processing one or more touch events on the touch screen display to obtain a value from the hour keypad comprise processing a touch down event or a touch in place event in a key of the hour keypad and using that value as the hour selection;
wherein, if the minute keypad is not already displayed, the minute keypad is displayed while a user is still touching the touch screen display following the processing of the touch event in a key of the hour keypad;
wherein the instructions for processing one or more touch events on the touch screen display to obtain a value from the minute keypad comprise processing a slide event to a key on the minute keypad; and processing a touch up event in a key of the minute keypad and using the value of that key as the minute selection.

16. A device comprising
a touch screen display; and
a processor executing programming logic for interfacing with the touch screen display; the programming logic configured to
display an hour keypad on the touch screen display;
process one or more touch events on the touch screen display to obtain a value from the hour keypad and use that value as an hour selection;
display a minute keypad on the touch screen display; and
process one or more touch events on the touch screen display to obtain a value from the minute keypad and use that value as a minute selection;
wherein the minute keypad comprises twelve keys, where each key corresponds to a multiple of five minutes of an hour.

17. The device of claim 16, wherein the programming logic is further configured to display a ten-digit keypad; and process one or more touch events on the touch screen display to obtain a value from the ten-digit keypad and use that value as a minute selection.

18. The device of claim 17, wherein the twelve-key and the ten-digit minute keypads are not wholly displayed at the same time.

19. The device of claim 18, wherein the programming logic is further configured to display a graphical widget, where the graphical widget enables a user to select whether the twelve-key or the ten-digit minute keypad is displayed.

20. The device of claim 18, wherein the programming logic is further configured to process a slide gesture, where the slide gesture enables a user to select whether the twelve-key or the ten-digit minute keypad is displayed.

21. The device of claim 16, wherein the programming logic configured to process one or more touch events on the touch screen display to obtain a value from the minute keypad is further configured to
process a touch down or touch in place event on the minute keypad to select a minute value;
process one or more movement events, where an offset of minutes is calculated for each movement event using a distance and direction of relative movement of touch position over the touch screen display;
combine the minute value with the offset of minutes for each movement event to generate revised minute values;
display the revised minute value for each movement event; and
process a touch up event to select the currently-displayed revised minute value.

22. The device of claim 16, wherein the programming logic configured to process one or more touch events on the touch screen display to obtain a value from the minute keypad is further configured to
process a touch in place event on the minute keypad to select an initial minute value;
display a minute sub-keypad containing minute values that are not multiples of five, where at least one of the minute values is one more or one less than the initial minute value; and
process a subsequent touch event on the sub-keypad to select a final minute value.

23. The device of claim 22, wherein the minute sub-keypad includes a key having the initial minute value.
